(19) United States
(12) Patent Application Publication
(10) Pub. No.: US 2004/0261512 A1
(43) Pub. Date: Dec. 30, 2004

(54) Wheel with plastic rim and integral sensor

(76) Inventors: Paul Desmond Daly, Troy, MI (US); Allan Losey, Ortonville, MI (US); Marcus E. Lewis, Southfield, MI (US)

Correspondence Address: SIEMENS CORPORATION, INTELLECTUAL PROPERTY LAW DEPARTMENT, 170 WOOD AVENUE SOUTH, ISELIN, NJ, 08830, US

(21) Appl. No.: 10/847,213

(22) Filed: May 17, 2004

Related U.S. Application Data
(60) Provisional application No. 60/474,564, filed on May 30, 2003.
(60) Provisional application No. 60/472,482, filed on May 21, 2003.

(51) Int. Cl. G01M 17/02

(52) U.S. Cl. 73/146

(57) ABSTRACT

A vehicle wheel is formed of a plastic rim that receives a tire. The tire is preferably welded at each of its two beads to portions of the rim. The plastic rim is preferably formed of both a disc and an internal part. A sensor for sensing pressures within the tire is incorporated into the disc piece. It is imagined that the entire vehicle wheel could be secured together for the life of the wheel. That is, the tire cannot be replaced. Since a plastic rim is utilized, the sensor could utilize LF (or other wireless means) to communicate a signal indicative of pressure, acceleration (which is translated into wheel speed), temperature and other information that may be deemed as important for safety and convenience from the tire to a receiver on the vehicle. Since the rim will not be separated from the tire, the sensor can also store incoming information providing a complete record of the entire life of the vehicle wheel. The sensor, or the vehicle receiver, is able to store information with regard to pressure, speed of operation, hours of operation, and other information which may be deemed as important for safety and convenience for the specific wheel, or wheels which are, or have been, mounted to the vehicle.

### BACKGROUND OF THE INVENTION

The application claims priority to U.S. Provisional Application No. 60/474,564 which was filed on May 30, 2003 and U.S. Provisional Application No. 60/472,482 which was filed on May 21, 2003.

This invention relates to a unique vehicle wheel, wherein a sensor is attached within the wheel and the rim is formed of a non-metallic material.

Vehicle wheels typically include an outer rubber tire secured to a rim. The rims have historically been formed of metal. Normally, the tire may be removed from the metal rim for replacement, as necessary.

Recently, plastics and composite materials have advanced to the point where they are sufficiently strong such that they could be utilized as wheel rims. However, there has not been sufficient motivation to drive this change.

Also, recently, tire pressure sensors have become required in the industry. Tire pressure sensors have typically been mounted in the prior art wheel at various locations. One common location incorporates the sensor adjacent to the air valve. Also, an antenna for transmitting signals from the sensor to a controller on the vehicle has been incorporated into the air valve. This has required the air valve to be formed of materials other than the standard rubber that has been previously utilized. It would be desirable to allow the use of standard air valves.

Another concern with the prior art tire pressure sensors is that the metal rims have made the transmission of signals from the sensor difficult. The signals have sometimes been difficult to send, due to the shielding of the signal that can occur from the metal rim. It would be desirable in many applications to send the sensor information via a wireless RF, LF or other such radio signal.

### SUMMARY OF THE INVENTION

In a disclosed embodiment of this invention, a vehicle wheel is manufactured utilizing a non-metallic rim. While plastic is preferred, other non-metallic materials, such as composites, may be utilized. A tire could be permanently attached to the plastic rim such that the rim will not allow replacement of the tire. A sensor and antenna are incorporated into the tire and rim, and record information about the operation of the vehicle wheel. Most preferably, the sensor is incorporated into a portion of the rim. The rim preferably is molded from two pieces of plastic, with an end disc and an internal rim part, fitting within the end disc. The sensor is preferably snapped into a mounting bracket molded to one of the two pieces that form the rim.

The disc initially receives one bead of the tire, and the internal rim part is then inserted into the disc. At that point, the other bead on the tire seats on the internal rim part. Both beads are then welded to the rim parts.

Preferably, a port is used to allow air pressure to reach the sensor from within a sealed volume in the tire. In this manner, the sensor receives pressure information, and can transmit and store this information. Moreover, the sensor is preferably provided with a speed sensor (which could be an accelerometer) and an antenna. The sensor is thus able to store not only information with regard to the tire pressure, but also information with regard to the speed of the tire, the hours of operation, etc. The sensor may be provided with a memory such that it stores an effective life history of the wheel. The sensor is also able to transmit signals to a control on the vehicle through a wireless connection. The sensor may be provided with its own battery, or may receive a charging signal as is known in the art to charge itself for transmission of the wireless signal.

These and other features of the present invention can be best understood from the following specification and drawings, the following of which is a brief description.

### BRIEF DESCRIPTION OF THE DRAWINGS

FIG. 1 is a cross-sectional view of a vehicle wheel incorporating the present invention.

FIG. 2 is an enlarged portion of the vehicle wheel along line 2-2 as shown in FIG. 1.

FIG. 3 is an exploded view of an inventive sensor mount.

FIG. 4 is an assembly view of the inventive wheel.

### DETAILED DESCRIPTION OF THE PREFERRED EMBODIMENT

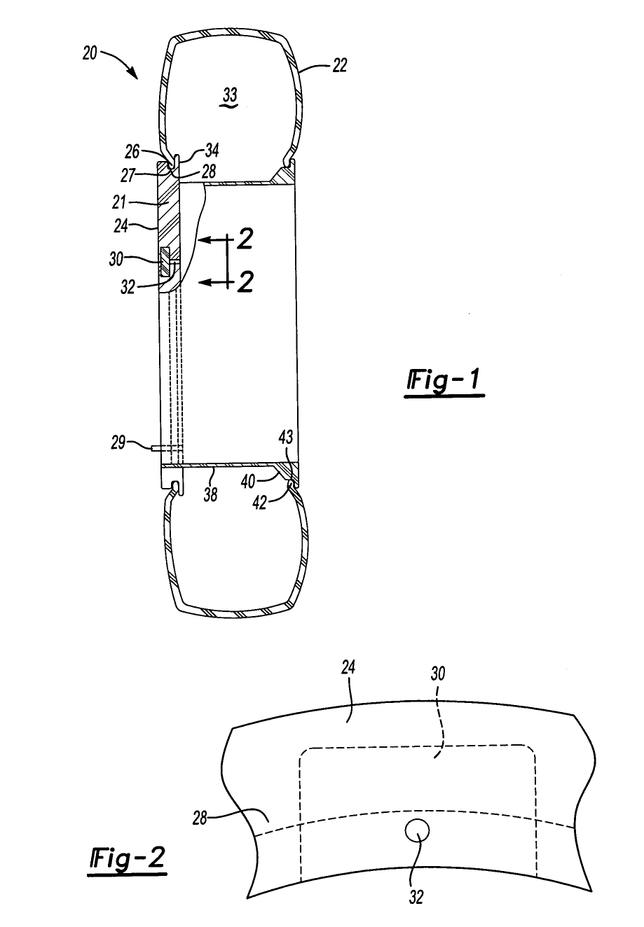

FIG. 1 shows a vehicle wheel 20 incorporating a tire 22. As is known, tire 22 has beads 26 and 42, which seal on a rim 21. The rim 21 includes an end disc 24 that receives bead 26 on a surface 28. An inner face 34 of disc 24 is positioned inwardly of the bead 26. A weld joint 27 secures the bead 26 to the surface 28. As shown schematically, an air valve 29 allows air to be inserted through the disc 24 and into an internal cavity 33 within the tire 22.

A sensor 30 is preferably mounted in the disc 24. A hole 32 communicates with the cavity 33, and supplies air pressure information to the sensor 30. Sensor 30 may be as known in the art, and is capable of reading the air pressure within the cavity 33, and storing information with regard to the pressure. Further, the sensor 30 is preferably provided with a speed sensor for sensing the speed of movement or rotation of the wheel 20. Sensor 30 is also preferably provided with the ability to transmit signals to the control on a vehicle. This transmission may be battery powered, or may be powered through an LF coupling, as is known. The disc 24 mates with an internal rim part 38 to form rim 21. Both disc 24 and internal rim part 38 are formed from a suitable non-metallic material, such as high strength plastic. As shown, a surface 40 receives the bead 42 from the tire 22. Again, a weld joint 43 secures the bead 42 to the surface 40.

As shown in FIG. 2, as can be appreciated, the sensor 30 is mounted within the disc 24. The hole 32 extends through the disc 24 to communicate air pressure to the sensor 30.

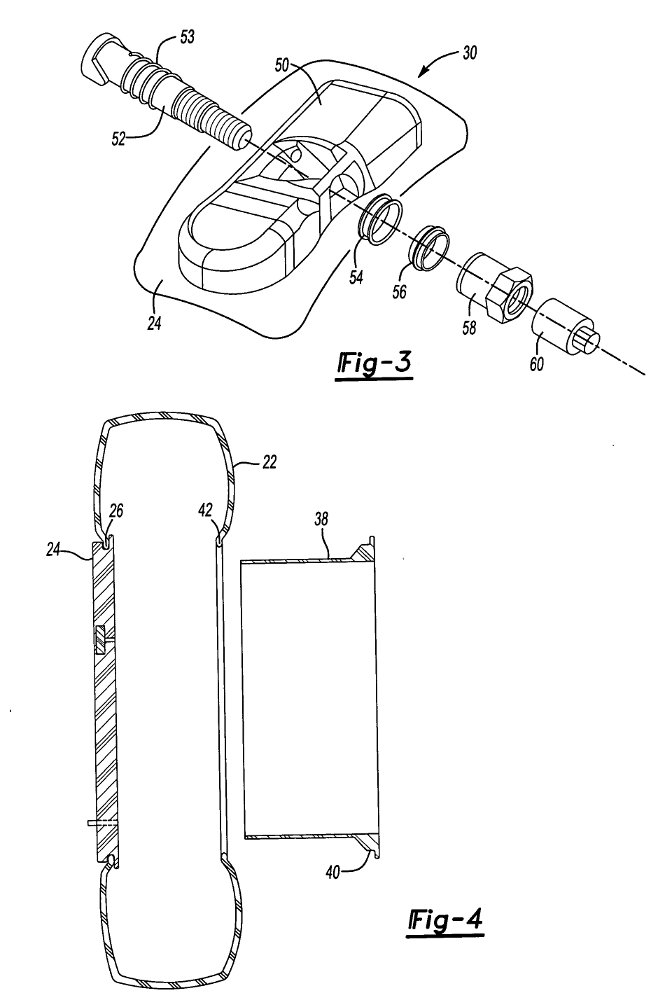

FIG. 3 is an exploded view of the sensor 30. As shown, a housing 50 receives the sensor body 52, and an antenna 53, shown schematically. The sensor body 52 and its communication with its antenna 53 may be as known in the art. Housing 50 is preferably molded into a portion of the disc 24. The sensor body 52 receives a plate 54, a seal 56, a nut 58, and a cap 60. The structure and operation of the sensor may again be as known in the art. Its location and incorporation into the rim, however, is inventive.

FIG. 4 shows another feature and in particular the assembly steps of the inventive vehicle wheel 20. As shown, the disc 24 initially receives the bead 26 from the tire 22. The internal rim part 38 is then moved into the inner periphery of the disc 24. The two rim parts may then be welded together, and the two beads 26 and 42 are welded to their respective surfaces, as is shown in FIG. 1. Preferably, laser welding may be used.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle wheel comprising:
a rim formed from a non-metallic material;
a tire having a pair of beads secured to said rim, and defining an enclosed chamber between said beads and said rim; and
a sensor for sensing a pressure in said enclosed chamber, said sensor communicating with air in said enclosed chamber, and said sensor being capable of transmitting a pressure signal outwardly of said vehicle wheel.

2. The vehicle wheel as set forth in claim 1, wherein said rim is formed of two pieces, with a disc receiving one bead of said tire and a second internal rim part secured to said disc and secured to a second bead of said tire.

3. The vehicle wheel as set forth in claim 2, wherein said sensor is mounted within said disc.

4. The vehicle wheel as set forth in claim 3, wherein said sensor receives an antenna.

5. The vehicle wheel as set forth in claim 4, wherein said sensor is capable of transmitting pressure information as an LF signal.

6. The vehicle wheel as set forth in claim 4, wherein said sensor is capable of transmitting pressure information as an RF signal.

7. The vehicle wheel as set forth in claim 2, wherein said sensor includes a speed sensor, said sensor recording information with regard to time of operation of said vehicle wheel, and speed of operation of said vehicle wheel.

8. The vehicle wheel as set forth in claim 7, wherein said sensor stores identification about which wheel is in service and the location on the vehicle.

9. The vehicle wheel as set forth in claim 1, wherein an air pressure hole extends through said disc to communicate air from said enclosed chamber to said sensor.

10. The vehicle wheel as set forth in claim 1, wherein said tire is not removable from said rim.

11. The vehicle wheel as set forth in claim 1, wherein said sensor is mounted within a housing molded to a portion of said rim.

12. The vehicle wheel as set forth in claim 1, wherein said rim is formed of a plastic.

13. A vehicle wheel comprising:
a rim molded from a plastic material;
a tire having a pair of beads secured to said rim, and defining an enclosed chamber between said beads and said rim;
said rim formed of two pieces, with a disc secured to a first bead of said tire and a second internal rim part secured to said disc and secured to a second bead of said tire; and
a sensor for sensing a pressure in said enclosed chamber, said sensor communicating with air in said enclosed chamber, and said sensor being capable of transmitting a pressure signal outwardly of said vehicle wheel, said sensor mounted in a housing molded to said disc, and an air communication hole formed through said disc to communicate air to said sensor from said enclosed chamber.

14. The vehicle wheel as set forth in claim 11, wherein said sensor stores a life history of the vehicle wheel.
